(19) United States
(12) Patent Application Publication
(10) Pub. No.: US 2014/0006915 A1
(43) Pub. Date: Jan. 2, 2014

(54) WEBPAGE BROWSING SYNCHRONIZATION IN A REAL TIME COLLABORATION SESSION FIELD

(71) Applicants: Judith H. Bank, Morrisville, NC (US); Lisa M. Bradley, Cary, NC (US); ChunHui Y. Higgins, Raleigh, NC (US); Lin Sun, Morrisville, NC (US)

(72) Inventors: Judith H. Bank, Morrisville, NC (US); Lisa M. Bradley, Cary, NC (US); ChunHui Y. Higgins, Raleigh, NC (US); Lin Sun, Morrisville, NC (US)

(73) Assignee: International Business Machines Corporation, Armonk, NY (US)

(21) Appl. No.: 13/535,947

(22) Filed: Jun. 28, 2012

(51) Int. Cl. G06F 17/00

(52) U.S. Cl. 715/205

(57) ABSTRACT

Embodiments of the present invention provide a system, method, and program product for web browsing synchronization between computers. In a real time collaboration session including a plurality of computers in which a URL link is entered into the real time collaboration session, a first computer of the plurality of computers receives a request to access a webpage via the URL link. The webpage is displayed a webpage browsing session on the first computer. The first computer receives information that one or more of the plurality of computers exclusive of the first computer requests to access the webpage. Each of the plurality of computers exclusive of the first computer synchronize a webpage in a webpage browsing session to the position of the webpage in the webpage browsing session of the first computer.

### FIELD OF THE INVENTION

The present invention relates generally to internet communication, and more particularly to webpage browsing while in a real time collaboration session.

### BACKGROUND

Online communications are an important collaboration technique for real time collaboration, which is also known as chat communications, and information sharing between individuals. In a real time collaboration, participants each participate on respective computers and communicate with each other through a network. Although chat sessions may include a large group of participants, chat sessions may consist of as few as two participants.

Chat sessions are utilized for a variety of different types of environments. For example chat sessions may be used for customer service support, business consultation, academic meetings, and more. These chat sessions provide a quick means to exchange information which may be difficult to exchange through more traditional avenues of real time collaboration. It is common for participants to discuss specific content, such as a webpage or document, in an online chat. In this scenario, a participant may send a uniform resource locator (URL) to the other participants in the chat session, and may focus the chat on a specific section of content in the webpage.

### SUMMARY

Embodiments of the present invention provide a system, method, and program product for webpage browsing synchronization in a real time collaboration session. Embodiments of the present invention provide a system, method, and program product for web browsing synchronization between computers. In a real time collaboration session including a plurality of computers in which a URL link is entered into the real time collaboration session, a first computer of the plurality of computers receives a request to access a webpage via the URL link. The webpage is displayed in a webpage browsing session on the first computer. The first computer receives information that one or more of the plurality of computers exclusive of the first computer requests to access the webpage. Each of the plurality of computers, exclusive of the first computer, synchronize a webpage in a webpage browsing session to the position of the webpage in the webpage browsing session of the first computer.

### BRIEF DESCRIPTION OF THE SEVERAL VIEWS OF THE DRAWINGS

FIG. 1 is a pictorial representation of a data processing system for a real time collaboration session in accordance with an embodiment of the present invention.

FIG. 2 is a flowchart depicting the steps of shared webpage browsing program in accordance with an embodiment of the present invention.

FIG. 3 is a flowchart depicting the steps of a chat session initiating program in accordance with an embodiment of the present invention.

FIG. 4 is a flowchart depicting the steps of a change leader program of a webpage browsing session in accordance with an embodiment of the present invention.

FIG. 5 is a flowchart depicting the steps of a program for a non-leader browsing program in a webpage browsing session in accordance with an embodiment of the present invention.

FIG. 6 is a flowchart depicting the steps of a leader disconnect program in accordance with an embodiment of the present invention.

FIG. 7 is a block diagram of components of computers depicted in accordance with an embodiment of the present invention.

### DETAILED DESCRIPTION

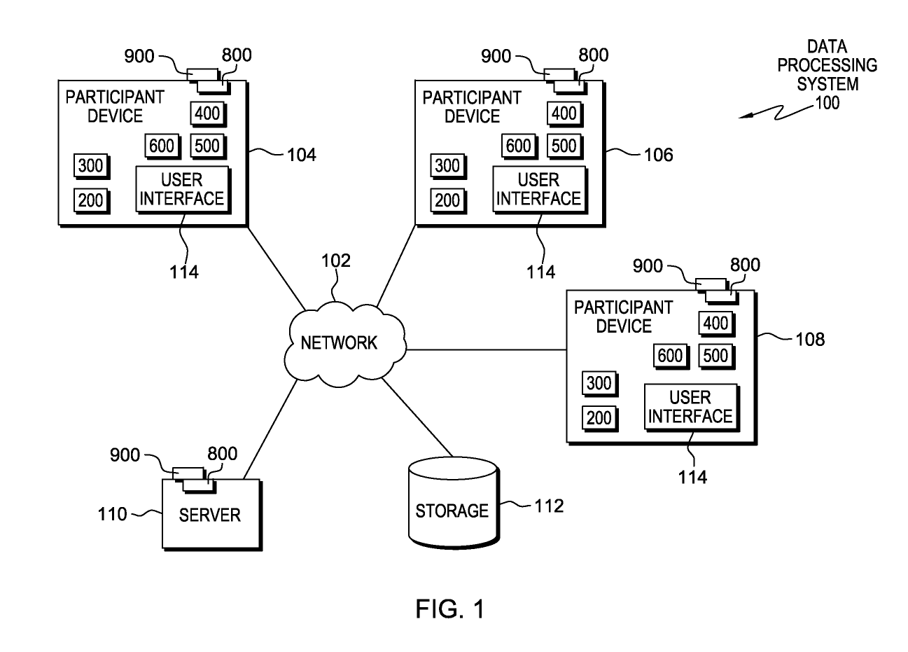

The present invention will now be described in detail with reference to the Figures. FIG. 1 illustrates a data processing system 100 in accordance to one embodiment of the present invention.

Data processing system 100 includes participant devices 104, 106, and 108, a server computer 110, and a storage device 112 connected through a network 102. Participant devices 104, 106, and 108 may be workstations, personal computers, personal digital assistants, mobile phones, and other devices executing program instructions. A user interface 114 is located on the participant device 104, 106, and 108 and may exist in the form of operating system software, which may be Windows, LINUX, or other systems that include application software such as internet applications and web browsers. In describing exemplary embodiments, a real time collaboration may refer to an online chat session, internet meeting, and/or other forms of communication and collaboration over a network 102.

Participant devices 104, 106, and 108 include a shared webpage browsing program 200 for establishing a shared webpage browsing session. In this example, participant devices 104, 106, and 108 include a chat session initiation program 300 for establishing a real time collaboration session. In this example, participant devices 104, 106, and 108 include a change leader program 400 to change the leader of a webpage browsing session responsive to a participant determination. In this example, participant devices 104, 106, and 108 include a non-leader browsing program 500 allowing participants to browse the webpage and then resynchronize with the leader. Participant devices 104, 106, and 108 include a leader disconnect program 600 to assign a new leader to a webpage browsing session in the event that the leader disconnects from the webpage browsing session. Data processing system 100 may include multiple different forms of participant devices 104, 106, and 108, and is not limited to a single type of device or a defined number of devices. Participant devices 104, 106, and 108 may be, for example, a notebook, a laptop computer, a tablet computer, a handheld device or smart-phone, a thin client, or any other electronic device or computing system capable of communicating with server computer 110 through network 102.

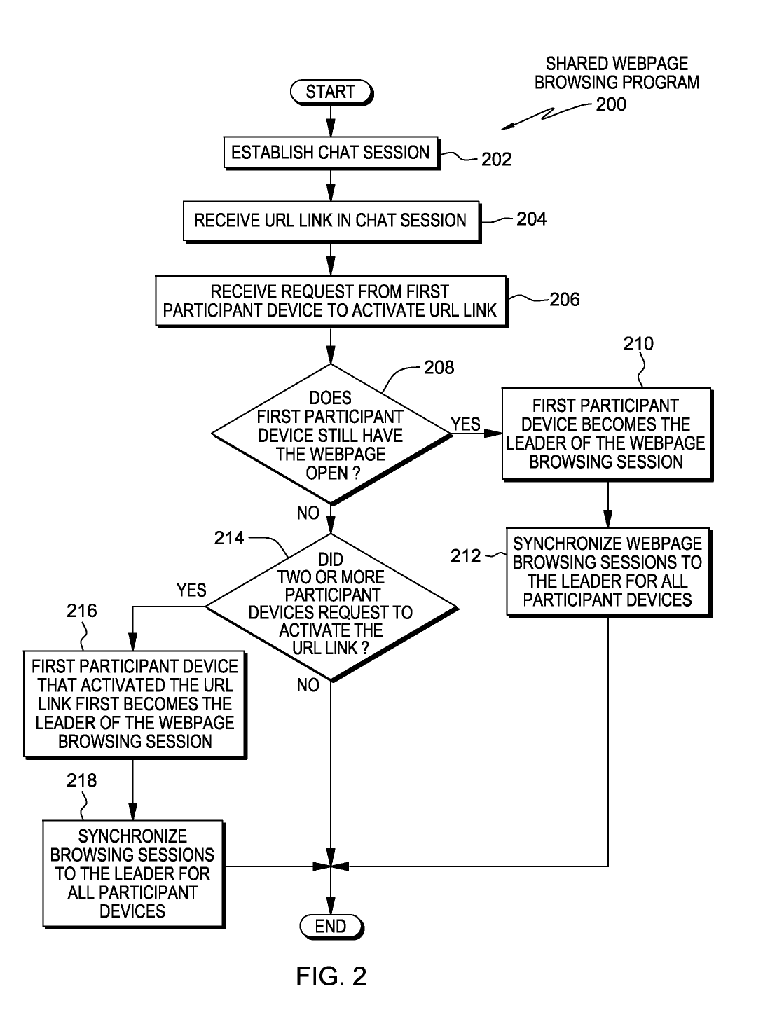

The programs described in FIGS. 2, 3, 4, 5, and 6 may be stored on participant devices 104, 106, and 108 in the form of programs on a real time collaboration client on participant devices 104, 106, and 108 computing system. However, in other examples, the programs may be stored on remote storage devices, servers, and other methods.

In one embodiment, data processing system 100 is comprised of network 102 which provides collaboration between devices such as, but not limited to, a server computer 110, a storage device 112, and participant devices 104, 106, and 108. Network 102 may include connections such as wiring, wireless communication link, fiber optic cables, and other forms of communication. Network 102 may allow elements of data processing system 100 to access content through a plurality of methods, including the internet, an intranet connection, telecommunications service provider, local area connection, and others. Participant devices 104, 106, and 108 can access server computer 110, storage device 112, and other participant devices 104, 106, and 108 through network 102. Server computer 110 may host real time collaboration client programs and facilitate connections through network 102. Examples of server computer 110 include application servers, communications servers, database servers, and other servers. In an example, storage 112 can host content which is available through network 102. Storage device 112 is not limited to a single device from a single provider, and can represent multiple storage locations from a multitude of providers.

In the depicted example, a chat session occurs between two or more participant devices 104, 106, and 108, and may be facilitated by server computer 110 through network 102. Participant devices 104, 106, and 108 may access documents and URL links which may be located on storage 112 through the network 102. URL links and documents may be provided by and shared between participant devices 104, 106, and 108 through network 102. The software hosting the chat and its programs may be located on participant devices 104, 106, and 108, or server computer 110 where the software is accessed through the network.

A chat session is initiated when, responsive to a user input into a participant device, the participant device connects to an Internet Relay Chat (IRC) protocol enabled server computer. In some examples, the server computer may or may not be the same server computer as a server computer that enables web browsing. The IRC protocol enabled server computer establishes a channel in which participant devices are able to communicate. Other participant devices may join this channel, and the IRC server computer mediates the channel by passing messages to participant devices connected through the channel designated by the originating participant device of the message, which is responsive to an input of the associated participant. In integrated Hypertext Markup Language (HTML) chat sessions, the real time collaboration session is incorporated into the HTML frame. The participant device can display an HTML page with an embedded chat window, and can send messages back to the originating server computer when the messages are typed into the chat window. Other implementations of HTML chat sessions run with a chat window adjacent to a Web browser window, so that the chat and browser applications run independently of each other. Examples of HTML chats with chat windows adjacent to the Web browser window rely on participant interaction to achieve coordination between the Web browser and the chat window. In some examples, participant devices 104, 106, and 108 sign in to a chat service so that a connection is established, via a network 102, to the server computer 110. Once the participant devices 104, 106, and 108 are signed in to the chat service, a communication path is established between the participant and the chat service. The communication path can be any connection between the participant and the chat service, and need not necessarily be with a Web server. The participant who initiated the chat session may invite other participants to join utilizing participant devices. Participants choosing to join the chat session will be connected to all other participants, including the participant who initiated the chat session, through the communication path from server computer 110. In some examples, the communication path may exist in the form of a connection which may be done through TCP (Transmission Control Protocol), UDP (User Datagram Protocol), or other methods implemented by the IRC.

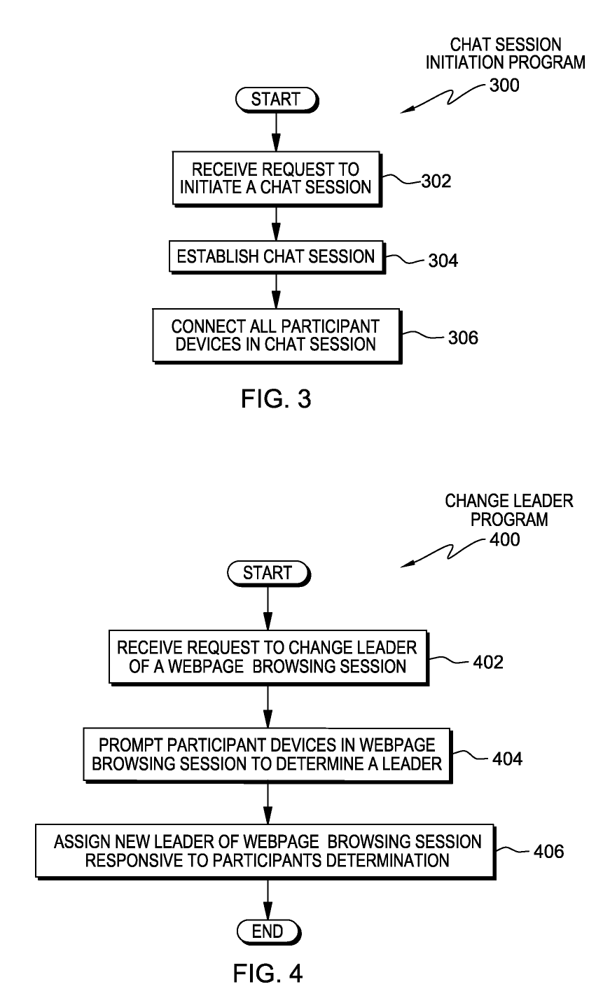

FIG. 2 is a flowchart of the shared webpage browsing program 200. In step 202 shared webpage browsing program 200 establishes a chat session between two or more participant devices. Further details of how a chat session may be established in at least one example is provided in the description of FIG. 3. Shared webpage browsing program 200 receives a URL link that was input into the chat (step 204). In step 206, shared webpage browsing program 200 receives a request a participant to access a webpage via the URL link received in the chat session. Shared webpage browsing program 200 determines whether or not the first participant device still has the URL link received in the chat session open in a web browser on the first participant device (decision block 208). If the first participant device does have the URL link received in the chat session open in a web browser on the first participant device, shared webpage browsing program 200 designates the first participant device to be the leader of the webpage browsing session (step 210). Shared webpage browsing program 200 synchronizes webpage browsing sessions for all participants to the position of the leader of the webpage browsing session previously designated (step 212). If the first participant does not have the URL link receive in the chat session open in a web browser on the first participant device, then shared webpage browsing program 200 determines whether or not two or more of the participant devices have requested to access the webpage via the URL link received in the chat session (decision block 214). If shared browsing program 200 determines that only one participant device has requested to access the webpage via the URL link received in the chat session, then no action is taken. If shared browsing program 200 determines that two or more participant devices and/or the first participant device have requested to access the webpage via the URL link received in the chat session, then the first participant device that accessed the webpage via the URL link becomes the leader of the webpage browsing session (step 216). Shared webpage browsing program 200 synchronizes webpage browsing sessions for participant devices to the position of the leader of the webpage browsing session previously designated (step 218).

In some examples, shared webpage browsing program 200 facilitates a more productive discussion of documents and URL links while in a chat session. In current iterations of real time collaboration sessions, participants discussing a URL link are not automatically synchronized to the position of the participant who is leading the discussion. This means that it may be difficult to ensure that all participants are discussing the same portion of a webpage. In an embodiment, all participants in a webpage browsing session are automatically synchronized to the same section of a webpage. Therefore, the participants of the webpage browsing session will be viewing the same section of the webpage, which may lead to a more productive chat session. In an example, when the second participant enters a URL link into the chat session, the URL link is then available for all participants in the chat session to access. The action of a participant selecting the URL link in the chat session may be achieved by a participant clicking on the URL link in the chat session displayed on a participant device associated with the participant. The selection of the URL link by additional participants does not have to coincide with the participant that initially selects the URL link. In an example, a participant may select the URL link once the webpage browsing session has already been established. In this event, the participant device will automatically join the existing webpage browsing session. The activation of the URL link by a participant device can be performed in a plurality of ways. For example, if a Web browser is not active in the participant device when the participant device receives an input to access a webpage via the URL link, the chat client may launch the Web browser using the URL as a command line argument. In another example, if a Web browser is already active in the participant device when the participant device receives an input to access a webpage via the URL link, the chat client communicates the page request to the Web browser using any suitable interface protocol.

In other examples, shared webpage browsing program 200 may assign the leader in response to a prompt to all participant devices that access the webpage via the URL link, assign the participant device who accessed the webpage first to be the leader, or other forms of dynamically determining the leader. Also, in the event that the activation of a URL link leads to a webpage that requires participant login information, in some examples, each participant may use the information of each participant for authentication, and then each participant device is synchronized to the participant device that is determined to be the leader. In an example, during the webpage browsing session where the first participant device is established as the leader, the updated position of the leader is communicated to the other participants via a communication path established between the members of the webpage browsing session. The communication path exists between all participants in the webpage browsing session and server computer 110.

FIG. 3 is a flowchart of chat session initiation program 300. In some examples, chat session initiation program 300 may be integrated with exemplary embodiments of shared webpage browsing program 200. In one example, chat session initiation program 300 receives a request to initiate a chat session between two or more participant devices, responsive to an input of a participant into a user interface of a corresponding participant device (step 302). Chat session initiation program 300 establishes the chat session (step 304). In step 306, chat session initiation program 300 connects all of the participant devices in the chat session.

In an example, responsive to an input of a participant into a user interface of a corresponding participant device, a participant device signs in to a chat service, and establishes a connection via a communication path through a communications network 102 to server computer 110. The participant device then has the option to invite other participant devices to a chat session. Once invited participant devices join the chat session, the invited participant devices are connected to all other participant devices in the chat session and server computer 110 via a communication path through communication network 102.

FIG. 4 is a flowchart of change leader program 400. In one example, change leader program 400 receives a request to change the leader of the webpage browsing session (step 402). Change leaders program 400 prompts the participants that are participating in the webpage browsing session on corresponding participant devices to determine a new leader (step 404). In response to the determination of a new leader by the participants in the webpage browsing session on corresponding participant devices, change leader program 400 assigns a new leader of the webpage browsing session (step 406).

In some examples, change leader program 400 allows the participants on corresponding participant devices to change leaders while each of the participants actively participate in a webpage browsing session. The request to change the leader in step 402 may be issued through a plurality of methods including, but not limited to: a participant device responding to an input by a participant, a participant device requesting to become the leader; the leader inviting a participant to become the leader, the leader leaving the webpage browsing session, or other methods. The prompt to determine a new leader may be achieved through, but not limited to: a prompt sent to all participant devices, a prompt sent to selected participant devices, an invite from the leader to a single participant device, or other methods. Change leader program 400 allows the leader of a webpage browsing session to be changed at the determination of the participants of the webpage browsing session. Change leader program 400 may not limit the webpage browsing session to having only one leader for the whole session. In some examples, multiple participants may have an expertise in different areas relating to the webpage being discussed in the webpage browsing session. With change leader program 400, the leader of the webpage browsing session may be changed to different participants when discussing different portions of the webpage in the webpage browsing session.

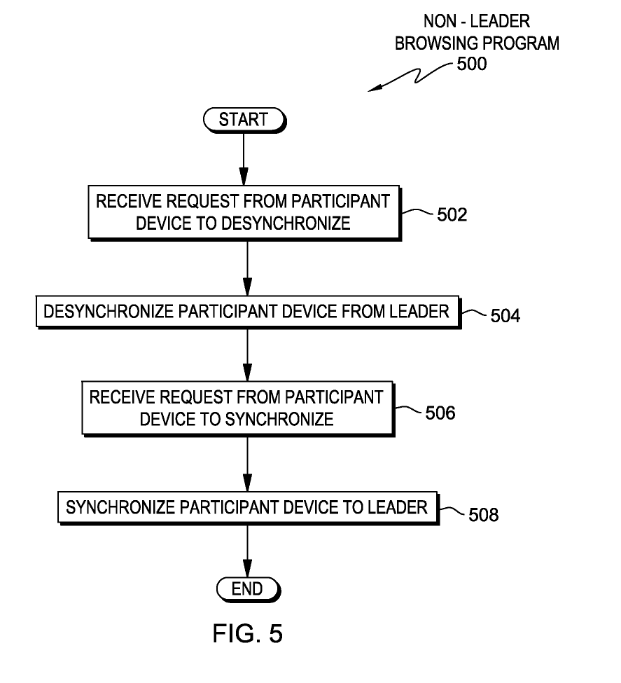

FIG. 5 is a flowchart of non-leader browsing program 500. In one example, non-leader browsing program 500 receives a request from a participant device to desynchronize from the leader of a webpage browsing session (step 502). In step 504, non-leader browsing program 500 desynchronizes the participant device that requested to desynchronize from the leader of a webpage browsing session. In some scenarios, after the participant has determined to desynchronize from the lead, the participant may desire to synchronize back with the leader of the webpage browsing session. Non-leader browsing program 500 receives a request from the participant device to synchronize with the leader of the webpage browsing session (step 506). In step 508, non-leader browsing program 500 synchronizes the participant device to the leader of the webpage browsing session.

In some examples, non-leader browsing program 500 allows a participant in a webpage browsing session to navigate throughout the webpage on a corresponding participant device, and then resynchronize with the leader of the webpage browsing session. Non-leader browsing program 500 may not limit the participant to only view the portion of the webpage that the leader is viewing. In an example, a participant may want to reference a portion of the webpage which had been previously discussed. In this example, the participant may desynchronize from the leader, browse the webpage, and then resynchronize with the leader at the desire of the participant. The participant device may request and desynchronize from the leader through multiple methods including, but not limited to: choosing an option to desynchronize/resynchronize that is displayed on a user interface of the chat session, navigating to a portion of the webpage, or other methods.

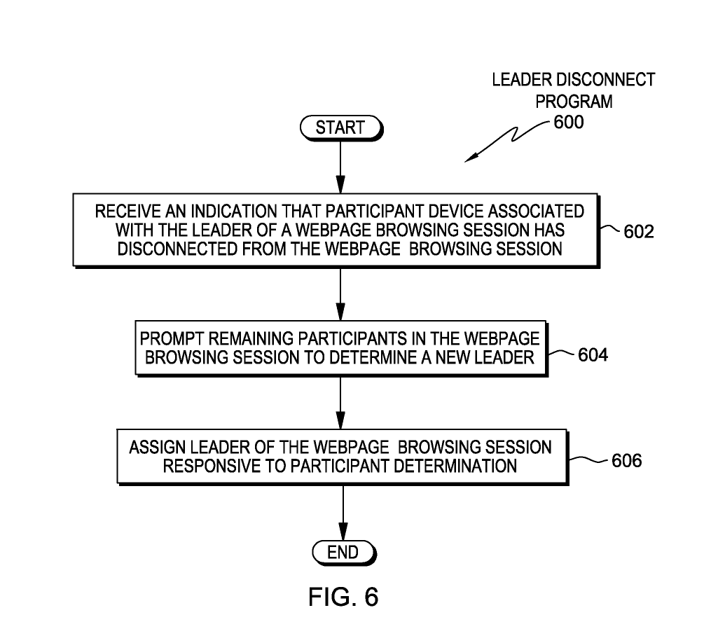

FIG. 6 is a flowchart of leader disconnect program 600. In one example, leader disconnect program 600 receives an indication that the participant device associated with the leader of a webpage browsing session has disconnected from the webpage browsing session (step 602). In step 604, leader disconnect program 600 prompts the remaining participant devices in the webpage browsing session to determine a new leader. In step 606, leader disconnect program 600 assigns a new leader of the webpage browsing session, responsive to the determination of the participants.

In some examples, leader disconnect program 600 allows the webpage browsing session to continue in the event that the leader has to disconnect from the webpage browsing session for any reason. The indication of the leader disconnecting in step 602 may be the result of the leader leaving the webpage browsing session, an interruption in the connection of the participant devices associated with the leader, the participant device associated with the leader crashing, or other reasons. The prompt to determine a new leader may be achieved through, but not limited to: a prompt for all participant devices, a prompt to selected participant devices, or other methods.

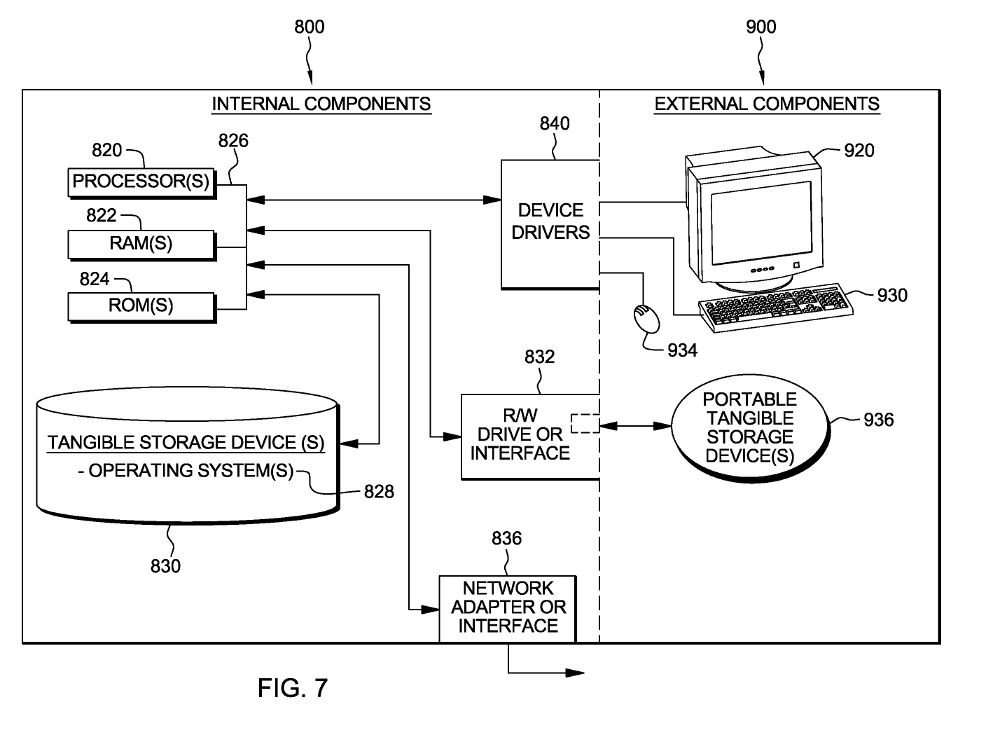

Participant devices 104, 106, and 108, and server computer 110 may include respective sets of internal components 800 and external components 900 illustrated in FIG. 7. Each of the sets of internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs 200, 300, 400, 500, and 600 in participant devices 104, 106, and 108, and server computer 110 are stored on one or more of the respective computer-readable tangible storage devices 830 for execution by one or more of the respective processors 820 via one or more of the respective RAMs 822 (which typically include cache memory). In the embodiment illustrated in FIG. 7, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more portable computer-readable tangible storage devices 936 such as a CD-ROM, DVD, memory stick, magnetic tape, magnetic disk, optical disk or semiconductor storage device. The programs 200, 300, 400, 500, and 600 can be stored on one or more of the respective portable computer-readable tangible storage devices 936, read via the respective R/W drive or interface 832 and loaded into the respective hard drive 830.

Each set of internal components 800 also includes network adapters or interfaces 836 such as a TCP/IP adapter cards, wireless Wi-Fi interface cards, or 3G or 4G wireless interface cards or other wired or wireless communication links. The programs 200, 300 400, 500, 600 can be downloaded to participant devices 104, 106, and 108, and server computer 110 or other computing devices from an external computer via a network (for example, the Internet, a local area network or other, wide area network) and respective network adapters or interfaces 836. From the network adapters or interfaces 836, the programs 200, 300, 400, 500, and 600 are loaded into the respective hard drive 830. The network may comprise copper wires, optical fibers, wireless transmission, routers, firewalls, switches, gateway computers and/or edge servers.

Each of the sets of external components 900 can include a computer display monitor 920, a keyboard 930, and a computer mouse 934. External components 900 can also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Programs 200, 300, 400, 500, 600 can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of programs 200, 300, 400, 500, and 600 can be implemented in whole or in part by computer circuits and other hardware (not shown). Based on the foregoing, computer system, method and program product have been disclosed in accordance with the present invention. However, numerous modifications and substitutions can be made without deviating from the scope of the present invention. Therefore, the present invention has been disclosed by way of example and not limitation.

What is claimed is:

1. In a real time collaboration session including a plurality of computers in which a URL link is entered into the real time collaboration session, a method comprising:
receiving at a first computer of the plurality of computers a request to access a webpage via the URL link;
displaying the webpage in a webpage browsing session on the first computer;
receiving at the first computer, information that one or more of the plurality of computers exclusive of the first computer requests to access the webpage; and
synchronizing in each of the plurality of computers exclusive of the first computer a webpage in a webpage browsing session to the position of the webpage in the webpage browsing session of the first computer.

2. The method of claim 1, wherein the first computer provides updates that are displayed on the one or more of the plurality of computers exclusive of the first computer requests to access the webpage.

3. The method of claim 1, further comprising:
designating the first computer of the plurality of computers to request access to the webpage via the URL link entered into the real time collaboration session to be a leader of the webpage browsing sessions synchronized in each of the plurality of computers.

4. The method of claim 3, further comprising the step of:
receiving at the first computer, information that one of the plurality of computers requests to become the leader of the webpage browsing sessions synchronized in each of the plurality of computers.

5. The method of claim 4, further comprising:
receiving at the first computer a prompt in the real time collaboration session to determine a new leader; and
responsive to an input by a participant into the real time collaboration session, receiving at the first computer a determination of the new leader in the webpage browsing session.

6. The method of claim 1, further comprising:
disconnecting by the first computer from the webpage browsing session;
receiving information at the first computer that at the plurality of computers exclusive of the first computer in the webpage browsing session a prompt in the webpage browsing session to determine a new lead computer; and
responsive to an input by a participant into a user interface of the plurality of computers exclusive of the first computer, receiving on the one plurality of computers exclusive of the first computer a determination of the new lead computer in the webpage browsing session.

7. The method of claim 1, further comprising:
receiving at the first computer, information that one of the plurality of computers exclusive of the first computer requests to desynchronize from the position of the webpage in the webpage browsing session of the first computer on the webpage browser session of the one of the plurality of computers exclusive of the first computer; and
desynchronizing from the position of the webpage in the webpage browsing session of the first computer of the webpage browsing session by the one of the plurality of computers exclusive of the first computer.

8. The method of claim 7, further comprising the steps of:
receiving at the first computer, information that the one of the plurality of computers exclusive of the first computer requests to synchronize a webpage in a webpage browsing session to the position of the webpage in the webpage browsing session of the first computer; and
synchronizing the webpage in the webpage browsing session of the one of the plurality of computers exclusive of the first computer to the position of the webpage in the webpage browsing session of the first computer.

9. A computer program product for use in a real time collaboration session including a plurality of computers in which a URL link is entered into the real time collaboration session, comprising:
one or more computer-readable, tangible storage devices;
program instructions, stored on at least one of the one or more storage devices, to receive at a first computer of the plurality of computers a request to access a webpage via the URL link;
program instructions, stored on at least one of the one or more storage devices, to display the webpage in a webpage browsing session;
program instructions, stored on at least one of the one or more storage devices, to receive at the first computer information that one or more of the plurality of computers exclusive of the first computer requests to access the webpage; and
program instructions, stored on at least one of the one or more storage devices, to synchronize in each of the plurality of computers exclusive of the first computer a webpage in a webpage browsing session to the position of the webpage in the webpage browsing session of the first computer.

10. The computer program product of claim 9, wherein the first computer provides updates that are displayed on the one or more of the plurality of computers exclusive of the first computer requests to access the webpage.

11. The computer program product of claim 9, further comprising program instructions, stored on at least one or the one or more storage devices, to designate the first computer of the plurality of computers to request access to the webpage via the URL link entered into the real time collaboration session to be a leader of the webpage browsing sessions synchronized in each of the plurality of computers.

12. The computer program product of claim 11, further comprising:
program instructions stored on at least one of the one or more storage devices, to receive information that one of the plurality of computers requests to become the leader of the webpage browsing sessions synchronized in each of the plurality of computers.

13. The computer program product of claim 9, further comprising:
program instructions stored on at least one of the one or more storage devices, to receive at the first computer a prompt in the real time collaboration session to determine a new leader; and
program instructions stored on at least one of the one or more storage devices, responsive to an input by a participant into the real time collaboration session, to receive at the first computer a determination of the new leader in the webpage browsing session.

14. The computer program product of claim 9, further comprising:
program instructions stored on at least one of the one or more storage devices, to disconnect by the first computer from the webpage browsing session;
program instructions stored on at least one of the one or more storage devices, to receive information at the first computer that at the plurality of computers exclusive of the first computer in the webpage browsing session a prompt in the webpage browsing session to determine a new lead computer; and
program instructions stored on at least one of the one or more storage devices, responsive to an input by a participant into a user interface of the plurality of computers exclusive of the first computer, to receive on the one plurality of computers exclusive of the first computer a determination of the new lead computer in the webpage browsing session.

15. The computer program product of claim 9, further comprising:
program instructions stored on at least one of the one or more storage devices, to receive at the first computer, information that one of the plurality of computers exclusive of the first computer requests to desynchronize from the position of the webpage in the webpage browsing session of the first computer on the webpage browser session of the one of the plurality of computers exclusive of the first computer; and
program instructions stored on at least one of the one or more storage devices, to desynchronize from the position of the webpage in the webpage browsing session of the first computer of the webpage browsing session by the one of the plurality of computers exclusive of the first computer.

16. The computer program product of claim 15, further comprising:
program instructions stored on at least one of the one or more storage devices, to receive at the first computer, information that the one of the plurality of computers exclusive of the first computer requests to synchronize a webpage in a webpage browsing session to the position of the webpage in the webpage browsing session of the first computer; and
program instructions stored on at least one of the one or more storage devices, to synchronize the webpage in the webpage browsing session of the one of the plurality of computers exclusive of the first computer to the position of the webpage in the webpage browsing session of the first computer.

17. In a real time collaboration session including a plurality of computers in which a URL link is entered into the real time collaboration session, a method comprising:
receiving a request to access a webpage via the URL link from a first computer of the plurality of computers;
displaying the webpage in a webpage browsing session on the first computer;
receiving a request to access the webpage from one or more of the plurality of computers exclusive of the first computer; and
synchronizing in each of the plurality of computers exclusive of the first computer a webpage in a webpage browsing session to the position of the webpage in the webpage browsing session of the first computer.

18. The method of claim 17, wherein the first computer provides updates that are displayed on the one or more of the plurality of computers exclusive of the first computer requests to access the webpage.

19. The method of claim 17, further comprising:
designating the first computer of the plurality of computers to request access to the webpage via the URL link entered into the real time collaboration session to be a leader of the webpage browsing sessions synchronized in each of the plurality of computers.

20. The method of claim 19, further comprising the step of:
receiving information that one of the plurality of computers requests to become the leader of the webpage browsing sessions synchronized in each of the plurality of computers.

21. The method of claim 20, further comprising:
sending a prompt in the real time collaboration session to determine a new leader; and
responsive to an input by a participant into the real time collaboration session, designating the new leader in the webpage browsing sessions synchronized in each of the plurality of computers.

22. The method of claim 17, further comprising:
receiving information that the first computer disconnected from the webpage browsing session;
sending a prompt in the real time collaboration session to determine a new leader; and
responsive to an input by a participant, determining the new lead computer in the webpage browsing sessions synchronized in each of the plurality of computers.

23. The method of claim 17, further comprising:
receiving a request to desynchronize from the position of the webpage in the webpage browsing session of the first computer on the webpage browser session of the one of the plurality of computers exclusive of the first computer; and
desynchronizing from the position of the webpage in the webpage browsing session of the first computer of the webpage browsing session by the one of the plurality of computers exclusive of the first computer.

24. The method of claim 23, further comprising the steps of:
receiving a request to synchronize a webpage in a webpage browsing session to the position of the webpage in the webpage browsing session of the first computer; and
synchronizing the webpage in the webpage browsing session of the one of the plurality of computers exclusive of the first computer to the position of the webpage in the webpage browsing session of the first computer.
